(19) United States
(12) Patent Application Publication
(10) Pub. No.: US 2020/0354059 A1
(43) Pub. Date: Nov. 12, 2020

(54) SURVEILLANCE WITH AN UNMANNED AERIAL VEHICLE

(71) Applicant: PROHIBITION X PTE. LTD., Singapore (SG)

(72) Inventors: Stephen D. NEWMAN, Singapore (SG); David L. NEWMAN, Adelaide (AU)

(21) Appl. No.: 16/762,375

(22) PCT Filed: Nov. 8, 2018
(86) PCT No.: PCT/SG2018/050562

§ 371 Date: May 7, 2020

(30) Foreign Application Priority Data
Nov. 8, 2017 (SG) 10201709203X

(51) Int. Cl. B64D 1/18; B60L 53/12; B64C 39/02

(52) U.S. Cl. CPC B64D 1/18; B60L 53/12; B64C 2201/127; B64C 2201/027; B64C 39/024

(57) ABSTRACT

An unmanned aerial vehicle includes a body, a propulsion system connected to the body. The propulsion system generates a lift force in a vertical direction opposite of a gravitational force when activated. In some cases, the unmanned aerial vehicle includes an applicator connected to the body. The applicator includes a channel, a chamber in fluid communication with the channel, and a nozzle in fluid communication with the channel.

### TECHNICAL FIELD OF THE INVENTION

The present disclosure relates generally to unmanned aerial vehicles, and specifically relates to monitoring and surveilling a geographic area or premises.

### BACKGROUND OF THE INVENTION

An unmanned aerial vehicle (UAV), often known as a drone, is a reusable aircraft without a human pilot aboard. Some UAVs can be controlled with a remote control, while other UAVs can operate autonomously. UAVs are often used for tasks in which human pilots are not desirable. Such tasks can be mundane, like package delivery. Other tasks can unnecessarily endanger the safety of a human pilot. For example, UAVs are used during search and rescue missions involving inclement weather. In fact, UAVs are used throughout many different industries including; military operations, agriculture, photography, the motion picture industry, and so on.

Many of these industries furnish drones with equipment used to collect data. For example, U.S. Patent Publication No. 2014/0316614 issued to David L. Newman, et al. teaches of a data collection system which utilizes a drone to survey a property and calculate a monetary quote to correct anomalies (e.g., replacing shingles, repairing asphalt, etc.). The data collection system of Newman provides a first computer media for collecting image data, a second computer media for analyzing the image data and locating anomalies in the image data, a third computer media for linking particular image data to address data of the property where the anomaly is present, and a fourth computer media for generating a list of pertinent properties having similar anomalies by address.

As previously noted, one of the benefits of utilizing a UAV to perform a task is the UAV's ability to operate without an onboard pilot. This ability allows for dangerous or mundane tasks to be performed remotely or autonomously, where piloting an aircraft would be impractical or costly. There are inherent issues, however, in using UAVs or drones to perform operations or tasks. For example, UAVs can only travel over a finite geographic area due to a reliance on batteries to supply electrical power to the drone. While operating a UAV, the off-board pilot or autonomous system programmer must always maintain enough electrical power in reserve to return the UAV from the current task. Otherwise, the operator would be forced to go to the remote site to retrieve the UAV. Another related issue includes the finite duration of time in which a UAV can operate. Again, due to a reliance on batteries to supply electrical power to the UAV, drones can only operate over a fixed period of time before the batteries need to be recharged or replaced. Thus, current UAVs are ill-suited for performing tasks involving a large geographic area, operation for an extended period of time, or both. While a group of UAVs can be utilized to perform a task over a large geographic area or for an extended duration of time, purchasing a group of UAVs can be expensive. Moreover, managing the operation of a large group of UAVs can be complicated and require additional costly resources (e.g., programmers, operators, batteries, maintenance, etc.).

In view of the foregoing and other issues, there is a need for improvements to UAV equipment including operation and charging.

### BRIEF SUMMARY OF THE INVENTION

According to an aspect of the present disclosure, an unmanned aerial vehicle (UAV) monitoring and surveillance system can be provided. In one embodiment, an unmanned aerial vehicle includes a body, a propulsion system connected to the body where the propulsion system generates a lift force in a vertical direction opposite of a gravitational force when activated, and an applicator connected to the body. The applicator includes a channel, a chamber in fluid communication with the channel, and a nozzle in fluid communication with the channel. The nozzle is angled to eject a fluid in an ejection direction that is angled with respect to the vertical direction.

The ejection direction can be transverse to the vertical direction.

The applicator can be a sprayer.

The sprayer can eject droplets having a size greater than 400 microns.

The propulsion system can generate a lateral force that is transverse the vertical direction in response to a command to change a non-vertical position.

The unmanned aerial vehicle can include a lachrymatory agent disposed within the chamber.

The lachrymatory agent can be capsicum spray.

The chamber can be affixed externally to the body.

The chamber can be defined by an inside surface of the body.

The unmanned aerial vehicle can include a downdraft deflector.

The propulsion system can include a rotor and the downdraft deflector can be positioned between the nozzle and the rotor where the downdraft deflector reduces drift effects of liquid ejected from the applicator caused by movement of the rotor when the rotor is rotating and the applicator is ejecting a liquid.

The propulsion system can generate a downdraft within a downdraft region when the propulsion system is activated and the nozzle can be located outside of the downdraft region.

The unmanned aerial vehicle can include an applicator control system. The applicator control system can include a camera, a memory, and a processor. The memory can include programmed instructions that, when executed, cause the processor to detect an intruder with the camera, move the body of the unmanned aerial vehicle proximate to the intruder, locate a facial feature of the intruder, aim the nozzle at the facial feature, and apply a liquid from the chamber through the nozzle into a face of the intruder.

In one embodiment, a method of using an unmanned aerial vehicle includes locating an intruder with a camera of the unmanned aerial vehicle and applying a lachrymatory agent towards a face of the intruder with a nozzle incorporated into the unmanned aerial vehicle.

The method can include moving the unmanned aerial vehicle to a position that is within six feet of the intruder

The method can include aiming the nozzle at a facial feature of the intruder.

The method can include generating a downdraft within a downdraft region when a propulsion system of the unmanned aerial vehicle is activated, wherein the nozzle is located outside of the downdraft region.

In one embodiment, an unmanned aerial vehicle includes a body, a propulsion system connected to the body where the propulsion system generates a lift force in a vertical direction opposite of a gravitational force when activated, a battery located within the body, a charging receiver in electrical communication with the battery, a camera connected to the body, memory, and a processor. The memory includes programmed instructions that, when executed, cause the processor to conduct a surveillance operation with the camera while receiving an electrical charge through the charging receiver.

The charging receiver can be an inductive coil.

The programmed instructions, when executed, can cause the processor to operate the propulsion system to move the unmanned aerial vehicle within a predetermined premises when the battery has a power level above a predetermined threshold.

The programmed instructions, when executed, can cause the processor to operate the propulsion system to dock the unmanned aerial vehicle at a charging station when the battery has a power level below a predetermined threshold.

The programmed instructions, when executed, can cause the processor to communicate with a remote device while the unmanned aerial vehicle is charging in response to detecting an intruder.

The programmed instructions, when executed, can cause the processor to communicate with a second unmanned aerial vehicle in response to detecting an intruder while charging.

The programmed instructions, when executed, can cause the processor to notify a second unmanned aerial vehicle of a location of an intruder in response to detecting the intruder while charging.

The programmed instructions, when executed, can cause the processor to send instructions to a second unmanned aerial vehicle to apply a lachrymatory agent to an intruder in response to detecting the intruder while charging.

The programmed instructions, when executed, can cause the processor to coordinate with a second unmanned aerial vehicle to perform the surveillance operation while charging.

The surveillance operation can include following or distracting an intruder.

In one embodiment, a method of using an unmanned aerial vehicle includes moving, with the unmanned aerial vehicle, through an air space superjacent a predetermined premises; performing, with the unmanned aerial vehicle, surveillance operations while moving; determining, with the unmanned aerial vehicle, that a power level of the unmanned aerial vehicle is below a predetermined threshold; docking the unmanned aerial vehicle to a charging station; and self-charging the unmanned aerial vehicle at the charging station while continuing to perform the surveillance operations.

Self-charging can include inductively charging the unmanned aerial vehicle at the charging station.

Moving the unmanned aerial vehicle within the air space of the predetermined premises can occur when the battery has a power level above the predetermined threshold.

The method can include communicating with a remote device while the unmanned aerial vehicle is charging in response to detecting an intruder.

The method can include communicating with a second unmanned aerial vehicle in response to detecting an intruder while charging.

The method can include notifying a second unmanned aerial vehicle of a location of an intruder in response to detecting the intruder while charging.

The method can include sending instructions to a second unmanned aerial vehicle to apply a lachrymatory agent to an intruder in response to detecting the intruder while charging.

The method can include coordinating with a second unmanned aerial vehicle to perform the surveillance operation while charging.

The method can include coordinating with the second unmanned aerial vehicle to perform the surveillance operation while moving about the air space when the power level is above the predetermined threshold.

In one embodiment, an unmanned aerial vehicle includes a body, a propulsion system connected to the body wherein the propulsion system generates a lift force in a vertical direction opposite of a gravitational force when activated, a camera connected to the body, a memory, and a processor. The memory including programmed instructions that, when executed, cause the processor to identify a person with the camera, lower the unmanned aerial vehicle with the propulsion system to a facial recognition level, analyze a face of the person with the camera in the facial recognition level, and classify the person as an intruder based on the analysis.

The facial recognition level can be even with the face of the person.

The facial recognition level can be within six feet of a plane that is level with the face of the person.

The unmanned aerial vehicle can include an applicator connected to the body. The applicator can include a channel, a chamber in fluid communication with the channel, and a nozzle in fluid communication with the channel. The nozzle can be angled to eject a fluid in an ejection direction that is angled with respect to the vertical direction.

The ejection direction can be transverse the vertical direction.

The applicator can be a sprayer.

The sprayer can eject droplets having a size greater than 400 microns.

The unmanned aerial vehicle can include a lachrymatory agent disposed within the chamber.

The lachrymatory agent can be capsicum spray.

The propulsion system can generate a lateral force that is transverse the vertical direction in response to a command to change a non-vertical position.

The memory can include programmed instructions that, when executed, cause the processor to coordinate with a second unmanned aerial vehicle when analyzing a face of the person with the camera, in the facial recognition level.

The memory can include programmed instructions that, when executed, cause the processor to compare facial features of the person to identities of cleared individuals, where classifying the person as the intruder is in response to failing to find a match of the facial features to an identity of a cleared individual.

The memory can include programmed instructions that, when executed, cause the processor to eject a lachrymatory agent towards the face of the intruder, in response classifying the person as the intruder.

In one embodiment, a method of using an unmanned aerial vehicle can include identifying a person with a camera of the unmanned aerial vehicle within a predetermined premises, lowering the unmanned aerial vehicle with a propulsion system of the unmanned aerial vehicle to a facial recognition level, analyzing a face of the person with the camera within the facial recognition level, and classifying the person as an intruder, based on the analysis.

The method can include coordinating with a second unmanned aerial vehicle when analyzing a face of the person with the camera in the facial recognition level.

The method can include comparing facial features of the person to identities of cleared individuals, where classifying the person as the intruder is in response to failing to find a match of the facial features to an identity of a cleared individual.

The method can include ejecting a lachrymatory agent towards the face of the intruder, in response classifying the person as an intruder.

The above summary of the present invention is not intended to describe each embodiment of every implementation of the present invention.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention can be realized by reference to the following drawings. In the appended figures, similar components or features can have the same reference label.

FIG. 1 illustrates a perspective view of an example of a UAV in accordance with the present disclosure.

FIG. 2 illustrates a perspective view of an example of a UAV moving to a charging station in accordance with the present disclosure.

FIG. 3 illustrates a perspective view of a first non-limiting application of the present disclosure.

FIG. 4 illustrates a perspective view of a second non-limiting application of the present disclosure.

FIG. 5 illustrates a perspective view of an example of a UAV performing a surveillance operation in accordance with the present disclosure.

FIG. 6 illustrates a perspective view of an example of a UAV performing a surveillance operation while charging in accordance with the present disclosure.

FIG. 7 illustrates a perspective view of an example of a UAV in accordance with the present disclosure.

FIG. 8 illustrates a perspective view of an example of a UAV in accordance with the present disclosure.

FIG. 9 illustrates a perspective view of an example of a UAV in accordance with the present disclosure.

FIG. 10A illustrates a side view of an example of a deflector in accordance with the present disclosure.

FIG. 10B illustrates a side view of an example of a deflector in accordance with the present disclosure.

FIG. 10C illustrates a side view of an example of a deflector in accordance with the present disclosure.

FIG. 10D illustrates a side view of an example of a deflector in accordance with the present disclosure.

FIG. 11 illustrates a perspective view of an example of a UAV performing a facial recognition analysis in accordance with the present disclosure.

FIG. 12 illustrates a perspective view of an example of a UAV ejecting a lachrymatory agent in accordance with the present disclosure.

FIG. 13 illustrates a perspective view of an example of a UAV communicating with another UAV while charging in accordance with the present disclosure.

FIG. 14 illustrates a perspective view of an example of a UAV communicating with another UAV while performing a surveillance operation in accordance with the present disclosure.

FIG. 15 illustrates a block diagram of an example of a control module for operating a UAV in accordance with the present disclosure.

FIG. 16 illustrates a block diagram of an example of a method of operating a UAV in accordance with the present disclosure.

FIG. 17 illustrates a block diagram of an example of a method of operating a UAV in accordance with the present disclosure.

FIG. 18 illustrates a block diagram of an example of a method of operating a UAV in accordance with the present disclosure.

FIG. 19 illustrates a block diagram of an example of a method of operating a UAV in accordance with the present disclosure.

FIG. 20 illustrates a block diagram of an example of a method of operating a UAV in accordance with the present disclosure.

FIG. 21 illustrates a block diagram of an example of a method of operating a UAV in accordance with the present disclosure.

FIG. 22 illustrates a side view of an example of a UAV docking with a charging station in accordance with the present disclosure.

Throughout the drawings, identical reference numbers designate similar, but not necessarily identical, elements.

### DETAILED DESCRIPTION OF THE INVENTION

The principles described in the present disclosure include the use of unmanned aerial vehicles (UAVs) or drones to perform surveillance or monitoring operations for a predetermined premises or geographic area. More specifically, the present systems and methods can allow for continuous monitoring or surveillance of large geographic areas or regions using a plurality of charging stations positioned within the geographic area or region. The present disclosure also provides systems and methods for monitoring a geographic area or premises for an extended duration of time using a plurality of charging stations positioned within the premises or geographic area. The principles disclosed herein can also include systems and methods to identify and deter unauthorized individuals from entering onto or otherwise interfering with the property, operation, or occupants of the premises.

In one aspect of the present disclosure, the UAV can be used in conjunction with a plurality of charging stations positioned within a geographic area at a series of predetermined locations. A first charging station can be separated from a second charging station a predetermined distance related to a range in which a UAV can travel before needing to recharge the UAV's power supply. A third charging station is positioned from the second charging station at a distance which can be, but does not have to be, approximately equal to the distance between the first and second charging stations, and so on. By periodically charging at various charging stations positioned within the large geographic area, the UAV can continuously monitor or survey the area. The number of charging stations utilized and the distance between each charging station can vary based on the size of the geographic area, the task to be performed, the limitations of the UAV's power supply (e.g., a lithium polymer battery), or a combination thereof.

For example, high-voltage overhead power transmission lines can span hundreds of miles, across varying environments. These transmission lines can be difficult to reach, or impractical to monitor using ground based transportation due to harsh landscapes and the remoteness of the overhead transmission lines. Using a UAV, as described within the present disclosure, however, a utility company responsible for maintaining transmission lines that span a large distance can continuously monitor the lines. A plurality of charging stations can be placed on or around the structures supporting the transmission lines. A UAV monitoring the transmission lines can land and recharge the UAV's power supply on each charging station positioned periodically along the length of the transmission lines. Thus, a single UAV or multiple UAVs can continuously monitor a significant expanse of overhead transmission lines over an interval of days, weeks, or months.

The UAV can include components that allow for wireless charging (i.e., inductive charging). In some embodiments, the UAV can inductively charge by landing on a charging station equipped with hardware that permits inductive charging. In other embodiments, the UAV can inductively charge as it flies over the transmission lines using the electromagnetic field emitted from the transmission lines themselves. In yet other embodiments, the UAV can inductively charge using a combination of the charging stations and the electromagnetic field emitted from the transmission lines. The UAV can also include components that allow for contact based charging (i.e., conductive charging). In some embodiments, the UAV can include at least one electrical contact or coil which physically contacts at least one charging element on the charging station to charge a battery of the UAV. The electrical contacts or coils can be composed of a conductive material, such as metal, which allows a predetermined amount of electricity to flow from the charging station to the battery of the UAV. The at least one electrical contact can be positioned on a skid of the UAV which contacts an upper surface of the charging station.

Monitoring a geographic area or premises can include visually inspecting structures or elements positioned within the area or premises for damage (e.g., a downed power line) using a camera operably attached to the UAV. Monitoring the geographic area can also include collecting data from structures or elements positioned within the region (e.g., measuring the electromagnetic field emitting from an overhead transmission line). The UAV can simultaneously charge and monitor an area in some embodiments. For example, the UAV can land on a charging station positioned on a structure supporting an overhead transmission line to charge the UAV's power supply. While the UAV is charging, the UAV can continuously take measurements related to the flow of electrical power through the lines and wirelessly transmit the measurements to a predetermined recipient. It should be appreciated that monitoring a geographic area can include any task in which data or information about the area is collected using a UAV (e.g., a drone).

In another aspect of the present disclosure, the UAV can be used in conjunction with a plurality of charging stations to monitor or surveil a predetermined premises for an extended duration of time. The UAV can include a camera or another data collection device to collect site data from the premises. The UAV can monitor the premises until the UAV's power supply or battery reaches a predetermined minimum threshold. When the power supply or battery reaches the predetermined minimum threshold, the UAV can travel to and land on a charging station to recharge the power supply to a predetermined maximum threshold. The UAV can continue to monitor and surveil the premises while on the charging station. For example, the premises can be a construction site housing valuable tools, materials, and other property. After the site is closed for the day, the UAV can travel to various locations within and around the construction site to monitor for movement. A charging station can be positioned near the entrance/exit of the construction site. After the UAV's power supply reaches a predetermined minimum threshold, the UAV can land on the charging station and monitor activity near the entrance/exit of the construction site while charging. Once the UAV's power supply is charged to a predetermined threshold, the UAV can once again travel to various locations within and around the construction site to monitor for movement. This process can be continuous or can be repeated until a foreman or site manager enters the site the following morning to resume construction.

The predetermined premises can be a premises in which monitoring is desired to protect property, pets, or individuals from unwanted intruders, natural disasters, accidents, industrial mishaps, attacks, other undesirable conditions, or combinations thereof. For example, the predetermined premises can include airports, warehouses, apartment buildings, complexes, universities, residences, business, loading docks, museums, government facilities, other types of facilities, other types of premises, testing sites, laboratories, land, a geographic area, or combinations thereof. In some cases, the UAV can be used after hours when few, if any, individuals are expected to be on the premises. In other examples, the UAV is intended for use during times of the day when authorized people are expected to be within the geographic area or on the premises.

In a related aspect of the present disclosure, the UAV can also be configured to conduct surveillance operations. The surveillance operations can include monitoring activities and/or reaction activities such as following an intruder, determining the identity of an intruder, communicating with authorities about the presence of a person on the premises, preventing a person on the premises from accomplishing an undesirable activity, searching for an intruder, investigating a scene, checking equipment or other valuables, responding to alarms, coordinating efforts with entities or other devices, coordinating efforts with another UAVs to accomplish a surveillance task, sending instructions to another UAV, executing a task from law enforcement, executing a task from another UAV, applying a chemical on an intruder, other activities, or combinations thereof. In some situations, the surveillance operation is carried out, at least in part, with a camera that is incorporated into the UAV. The surveillance activities can be done at any appropriate time of the day. In some examples, the surveillance activities are done at night. In some of the operations done during the night hours, the operations can occur in a silent mode. In other cases, the operations can occur during the day hours. In some of these situations, the operations can be performed in a non-silent mode.

In another aspect of the principles described in the present disclosure, the UAV can determine when the UAV has a power level below a predetermined minimum threshold. The UAV can respond to the determination of the minimum or low power threshold by moving towards a charging station and docking at the charging station in such a way that allows the UAV's power supply to charge. The UAV can continue to perform surveillance operations while the UAV is charging. In some examples, the UAV communicates with another UAV and/or a central computing system while charging. The communications can include instructions to the UAV to perform a surveillance operation, notify the other UAV and/or a central computing system about a person on the premises, tell the other UAV and/or a central computing system the location of the person, update the other UAV and/or a central computing system about the activities of the person, or combinations thereof. In some cases, surveillance operations performed by the UAV include identifying a person on the premises, following a person with the camera, searching for a person with the camera, performing another task with the camera, or combinations thereof.

The UAV can determine when the UAV's power level is fully restored (e.g., a maximum threshold) or at least restored to a sufficient level to leave the charging station and perform another task. In some cases, the UAV can leave the charging station before the UAV is reaches a maximum threshold or is otherwise fully charged, but has a charge sufficient to carry out a task that has a higher priority than becoming fully charged. For example, the UAV can identify a person on the premises who is leaving the UAV's field of view behind obstacles. In those instances, where the UAV has a charge sufficient to leave the charging station to identify the person before the UAV loses track of the person, the UAV can temporarily halt the charging activity to ensure that the person's identity is discovered.

The charging stations can be strategically located so that the UAV can be positioned to take measurements, monitor an area, or otherwise view areas of interest while charging. Thus, the UAV can continue to perform monitoring, data collection, or surveillance operations while charging. In some examples, the charging stations are covert and difficult for an intruder to notice. In other examples, the charging stations can be overt observation posts.

In another aspect of the present disclosure, the UAV can include facial recognition capabilities that allow the UAV to determine the identity of a person within the geographic area or on the premises. The UAV can use the camera to identify the location of the person. In some embodiments, to use the facial recognition features, the UAV can lower its altitude to obtain a view adequate for distinguishing the characteristics of the person's face. This facial recognition level can include being within six feet of the person. In this example, the UAV can be higher than the person, but still be positioned at an angle that allows the UAV to see the person's facial features. In some examples, the facial recognition level is substantially at the same altitude as the person's face. At this altitude, the UAV can have an unobstructed view of the person's facial features. In some examples, the UAV obtains multiple views of the person to determine the characteristics of the person's facial features.

The facial features captured by the camera can be analyzed to determine whether the person belongs to a group that is authorized or at least allowed to be on the premises. This analysis can include determining the dimensions of the person's facial features, the color of the person's facial features, the contrast of the person's facial features, the depth of the person's facial features, other characteristics of the person's face, or combinations thereof. In response to determining these facial characteristics, the characteristics can be compared to the characteristics of individuals who are cleared for being on the premises. Those who are cleared to be on the premises can include employees of a business, owners of equipment or merchandise on the premises, security personnel, family members of employees or owners, other individuals identified as cleared individuals, or combinations thereof.

In some examples, when a match exists between at least one facial feature of the person analyzed by the UAV and a characteristic of a cleared individual, the UAV can determine that the person is a cleared individual. In other examples, the UAV can only determine that the person is a cleared individual if the person has at least two facial features that match those of a cleared individual. Any appropriate number of matching features between the person analyzed by the UAV and one of the cleared individuals can be used to determine when a match occurs between the person and the cleared individual. In those circumstances where no matching facial characteristics are identified or insufficient facial features match to pass a confidence threshold that the person is a cleared individual, the UAV can classify the person as an intruder.

The UAV can also be configured to identify intruders by any number of identification modes. According to one embodiment, the UAV can be configured to visually identify a badge, a cap, a helmet, or another identifying feature associated with a first responder. Additionally, a transmitter such as a Bluetooth or Radio transmitter, an RFID tag, or other signal/light/sound transmitter can be used to communicate or disable the UAV.

Similarly, according to one embodiment, the UAV is equipped with a processor, a transmitter, an antenna, and a receiver configured to receive radio signals from a cell phone. According to this embodiment, the UAV is configured to receive signals from a paired cell phone, receive control signals from the cell phone, and transmit data back to the cell phone. Additionally, the processor can be configured to use the transmitter to transmit status information, video and/or audio recordings. The information can be transmitted over any number of communications mediums including, but not limited to, radio frequency (RF), Wi-Fi, Bluetooth, or any other suitable signal propagation medium.

The UAV can respond to the determination of an intruder in any appropriate manner. In those circumstances where the intruder appears to be conducting himself or herself in a relatively harmless manner, the UAV can notify law enforcement of the intruder's presence. In those situations where the UAV determines that the intruder's activity is harmful or at least potentially harmful, the UAV can attempt to chase the intruder off the premises. In another example, the UAV can produce an audible message instructing the intruder to leave. In those cases where the intruder appears undeterred in his or her activities and/or becomes aggressive towards the UAV, the UAV can eject a non-lethal deterrent, such as a lachrymatory agent like pepper spray, towards the individual to encourage the intruder to stop his or her activity, temporarily disable the intruder, and/or encourage the intruder to leave the premises.

In some cases, the UAV can be aware of the amount of resources it has. For example, the UAV can determine when it needs to go to a charging station and recharge its battery. In some situations, the UAV can know when it needs to refill an applicator agent, such as a lachrymatory agent. In some cases, the payload, such as lachrymatory agent, is desirable in small amounts to keep the UAV's overall weight down. This allows the UAV to remain in the air longer and have sufficient resources to complete tasks or objectives, while allowing for the UAV to reload as needed between applications.

According to one exemplary embodiment, the UAV can be capable of self-learning. For example, the facial recognition system can be able to learn who is authorized to be in the predetermined area. In examples where the predetermined area is a residence, the UAV can learn through facial and/or body recognition who is to be recognized as family, friends, and/or pets that are allowed in the area unless they are observed in compromised activities and/or compromised locations. The UAVs can also have the capability of working with other UAVs to provide better and redundant coverage. In some examples, the UAVs can be self-aware of their space and have a capability of mapping their territory and updating their surroundings (objects being moved, stolen, and so forth). The UAV can be capable of operating in poor lighting conditions as well as in good lighting conditions and conditions that do not have any lighting at all, using infrared or other portions of the light spectrum. The UAV can be capable of observing, identifying non-constant situations, and monitoring them. For example, the UAV can identify intruders, pets, and/or house members that are in an accident. Further, the UAV can be able to learn to react to many standard & nonstandard situations.

Other non-limiting applications of the present disclosure include; performing tasks related to border security, monitoring railway lines, monitoring oil and natural gas pipelines, mining surveillance, intruder recognition and deterrence, and other similar applications.

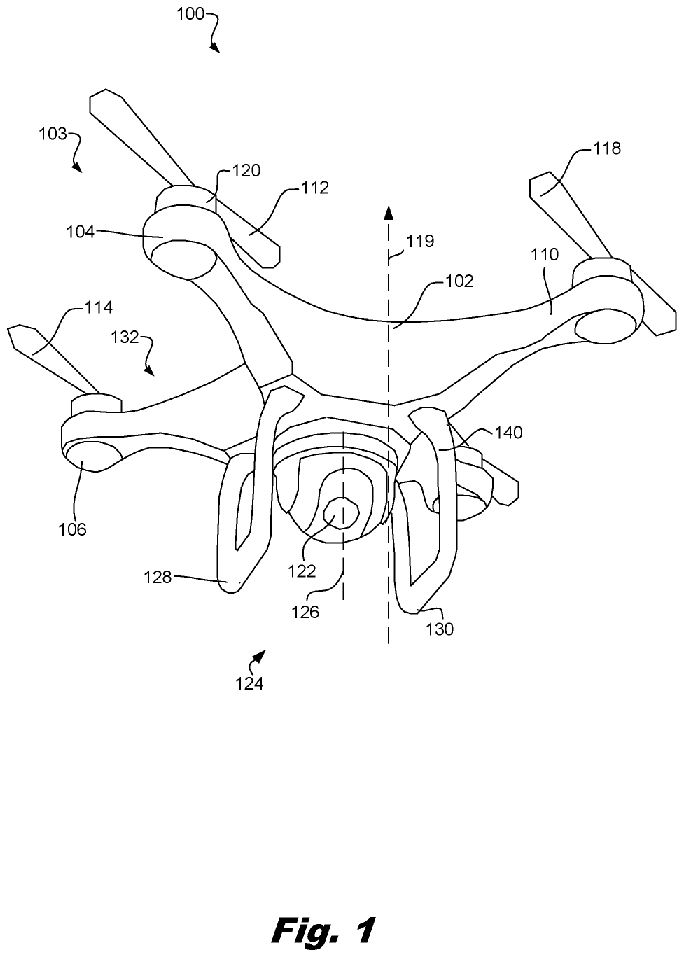

Now referring to the figures, FIG. 1 depicts an embodiment of a UAV 100. In this embodiment, the UAV 100 is a quadcopter style UAV. The UAV 100 has a body 102 with a first arm 104, a second arm 106, a third arm (obscured from view), and a fourth arm 110. A propulsion system 103 of the UAV 100 includes a first rotor 112 connected to the first arm 104, a second rotor 114 connected to the second arm 106, a third rotor (obscured from view) connected to the third arm, and a fourth rotor 118 connected to the fourth arm 110. Each of the rotors create lift when the rotor rotates. The first rotor 112 and the third rotor can rotate in a clockwise direction while the second rotor 114 and the fourth rotor 118 can rotate in a counterclockwise direction. When one of the rotors rotates, the rotor creates a counter force to rotate the UAV's body 102 in an opposite direction of the direction that the rotor is rotating. With two of the rotors rotating in a clockwise direction, and the other two rotors rotating in a counterclockwise direction, the counter forces are balanced. Thus, when each of the rotors rotate with an equal amount of power, the counter forces are balanced resulting in the UAV being lifted in a vertical direction 119. The yaw of the UAV can be controlled be adjusting the thrust of just the rotors that are rotating in a single direction. Further, the roll and pitch of the UAV can be controlled by applying more thrust to just one of the rotors. To cause the UAV 100 to move horizontally or in a direction that is transverse the vertical direction 119, a swashplate 120 that connects each of the rotors to their respective arms can change the angle of the blades or vanes and therefore cause the UAV 100 to move in a direction that is transverse the vertical direction.

According to one example, the vanes can include a vane design, geometry, material, surface finish, and/or additional feature to minimize sound and increase stealth of the UAV. In one example, the vane is feathered to reduce or eliminate audible rotor wash. Alternatively, a motor and/or motor shield can be fitted adjacent to the rotor or motor to reduce audible sound of the UAV. Wave cancelling systems can be used to minimize sound emanated by the UAV. In one instance, a counter-rotating vane can be implemented to provide a cancelling soundwave. Alternatively, a microphone, processor, and speaker can be implemented to actively analyze and cancel any noise made by the UAV, thereby adding stealth.

While this example has been described with reference to the UAV being a quadcopter, any appropriate type of UAV can be used. A non-exhaustive list of UAVs that can be compatible with the principles in the present disclosure include tricopter, quadcopter, hexacopter, octocopter, other multicopters, a fixed wing drone, a rotary wing drone, another type of drone, or combinations thereof.

As illustrated in FIG. 1, the UAV can also include a camera 122 that is connected to the underside 124 of the UAV's body 102. In this example, the camera 122 has the ability to swivel about a rotary axis 126 and to change angle with respect to the axis 126. In this example, the UAV 100 also includes a first skid 128 and a second skid 130 (e.g., a landing component) attached to the underside 124 of the body 102. The UAV can rest on the first and second skids 128, 130 when landed. In this embodiment, the camera 122 is located between the first skid 128 and the second skid 130.

Any appropriate type of camera can be used in accordance with the principles described in the present disclosure. For example, the camera can be a visible light camera, a digital camera, a distance camera, a time of flight camera, an infrared camera, an acoustic camera, a broad spectrum cameras, a high resolution cameras, another type of camera, or combinations thereof. While this example has been described with a camera capable of moving in specific directions and having specific characteristics, the camera can be mounted to the UAV differently than depicted in FIG. 1 and have more degrees of freedom to move than depicted in FIG. 1 or less degrees of freedom to move than depicted in FIG. 1.

In some cases, the UAV 100 can include detection systems that do not include a camera. For example, a non-exhaustive list of detection systems that can be incorporated into the UAV 100 include camera type detection systems, radar type detection systems, sonar type detection systems, acoustic type detection systems, visual type detection systems, other types of detection systems, or combinations thereof. The UAV 100 can also include hardware configured to collect data. For example, the UAV 100 can be equipped with sensors or probes designed to measure ambient electromagnetic fields propagating around the UAV 100.

In some cases, the UAV 100 can be in a detection and record mode where the UAV's functions including monitoring the predetermined area and recording activities or circumstances. In other cases, the UAV 100 can be in an alarm and attack mode where the UAV 100 notifies authorized personnel about intruders, sounds an alarm to indicate to the intruder and others the intruder's presence, and engage the intruder. In some cases, engaging the intruder includes applying an irritant to the intruder, such as a chemical, electrical, acoustic, or visual type of irritant. In some cases, the user can switch between the passive and attack modes based on a command from an authorized source, based on a trigger event, based on another type of condition, or combinations thereof.

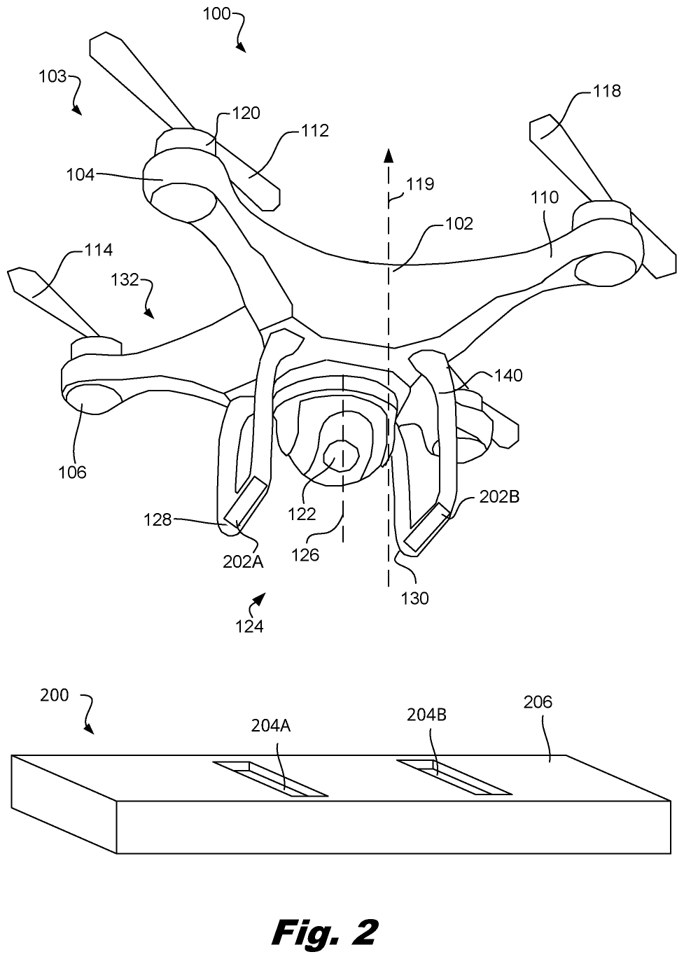

FIG. 2 depicts an example of a UAV 100 having a first skid 128 and a second skid 130. In the illustrated example, a first charging receiver 202A and a second charging receiver 202B are incorporated into the first and second skid 128, 130 respectively. The charging receivers 202A, 202B can be located to be proximate electrical contacts or coils of a charging station 200. In the example depicted in FIG. 2, the charging station 200 includes slots 204A, 204B to receive the skids 128, 130. The coils and/or electrical contacts can be located inside of the slots 204A, 204B or adjacent to the slots 204A, 204B such that when the UAV 100 docks at the charging station 200 with the first and second skids 128, 130 positioned within the slots 204A, 204B, the UAV 100 can be aligned for charging the UAV's battery. While slots are shown, the coils and/or electrical contacts can be on a flat, curved, or other shaped surface.

In some cases, the charging receivers 202A, 202B are electrical contacts that complete an electrical circuit when positioned within the slots 204A, 204B. The electrical circuit can include a battery of the UAV 100 which draws electrical power from the charging station 200. In another example, the charging station 200 can be an inductive charging station. In this example, the first and second charging receivers 202A, 202B are inductive couplers that do not have to make direct contact with the inductive coils of the charging station 200. Inductively charging the UAV 100 is convenient as the UAV 100 can be misaligned with the inductive coils of the charging station 200 and still receive a charge.

The UAV 100 can be configured to determine its own power level. In those circumstances where the UAV 100 determines that the UAV's power level is below a minimum predetermined threshold, the UAV 100 can move towards the charging station 200, dock at the charging station 200, and receive a charge. In some situations, the UAV 100 can also determine when the UAV 100 is fully charged or at least partially charged. In this manner, the UAV 100 can know when to remain docked at the charging station 200 and when to leave the charging station 200.

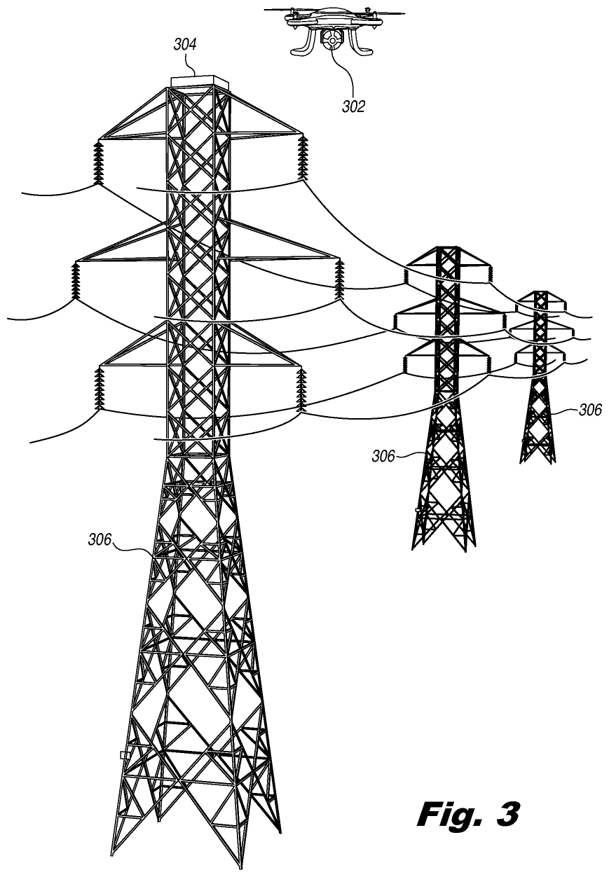

FIG. 3 depicts a non-limiting application of the present disclosure. In the application depicted in FIG. 3, a UAV 302 can be utilized to monitor an expanse of overhead transmission lines 306. The UAV 302 can travel some range before docking on a charging station 304 positioned on a structure of the expanse of transmission lines 306. For example, the charging station 304 can be a first charging station positioned some distance along the expanse of overhead transmission lines 306. After docking and charging on the charging station 304, the UAV 302 can continue to travel along the expanse of overhead transmission lines 306 until the battery of the UAV 302 reaches a minimum power threshold. After the reaching the minimum power threshold, the UAV can dock on another charging station (not depicted) located some distance from the first charging station 304. Thus, the UAV 302 can monitor a large expanse of overhead transmission lines continuously by periodically recharging at a plurality of charging stations position on or near the overhead transmission lines 306.

The charging station 304 can be equipped with hardware that allow for conductive charging, inductive charging, or both. Likewise, the UAV 302 can be equipped with hardware that allow the UAV 302 to recharge a power supply (e.g., a battery). For example, the UAV can include skids or another device positioned below the body of the UAV. The skids can include electrical contacts which contact a surface of the charging station to charge the power supply of the UAV. Alternatively, the skids can include hardware configured to wirelessly charge (e.g., inductively charge) the power supply of the UAV while docked on the charging station. In another embodiment, the battery of the UAV 302 can wirelessly charge using the electromagnetic field generated by the overhead transmission lines 306 as the UAV 302 flies within proximity of the overhead transmission lines 306.

The charging station 304 can be positioned on the structure supporting the transmission lines (e.g., a steel tower, a wooden pole, etc.) in some embodiments. The charging station 304 can also be in electrical communication with one or more of the transmission lines 306 to supply electrical power to the charging station 304. For example, the charging station 304 may be include a step-down transformer and an AC-to-DC converter to supply adequate electrical power to the charging station 304 to charge the UAV 302. In another embodiment, the charging station 304 can include a series of coils which interact with the electromagnetic field emitted from the transmission lines 306 to induce current within the coils. Thereby supplying electrical power to the charging station 304. It should be appreciated that a charging station can generate or receive electrical power using a variety of methods. For example, solar power, wind power, induction, conduction, and so on.

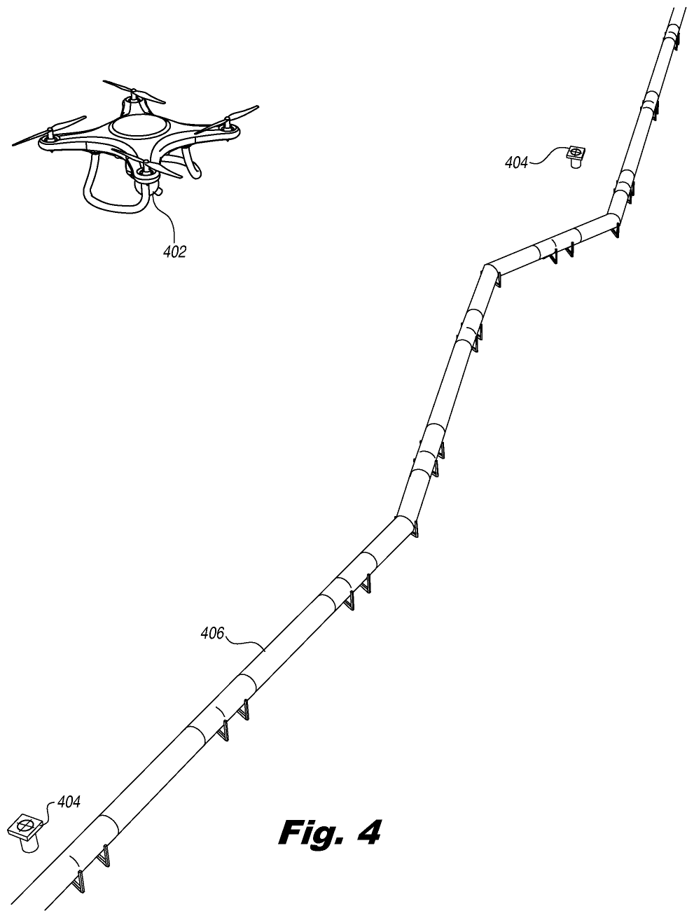

FIG. 4 depicts a non-limiting application of the present disclosure. In the application depicted in FIG. 4, a UAV 402 can be utilized to monitor an oil pipeline 406. The UAV 402 can travel some range before docking on a charging station 404 positioned proximate to the oil pipeline 406. For example, the charging station 404 can be a first charging station positioned a distance along the pipeline 406. After docking and charging on the charging station 404, the UAV 402 can continue to travel along the oil pipeline 406 until the battery of the UAV 402 reaches a minimum power threshold. After the reaching the minimum power threshold, the UAV can dock on another charging station (not depicted) located some distance from the first charging station 404. Thus, the UAV 402 can monitor an oil pipeline 406 or other expansive area continuously by periodically recharging at a plurality of charging stations position on or near the pipeline 406.

The UAV 402 can be equipped with a camera to visually inspect the oil pipeline 406 for leaks or an oil spill emanating from the pipeline. The UAV 402 can also be equipped with other hardware configured to wirelessly receive data (e.g., flowrate, temperature, viscosity, etc.) from an electronic device positioned on or near the oil pipeline 406.

The charging station 404 can be positioned on the oil pipeline 406 in some embodiments. In other embodiments, the charging station 404 can be positioned on the structure supporting the oil pipeline 406. In yet other embodiments, the charging station 404 can be positioned adjacent to the oil pipeline 406. The charging station 404 can generate or receive and/or store electrical power using a variety of methods. For example, solar power, wind power, induction, conduction, battery banks, direct lines, and so on.

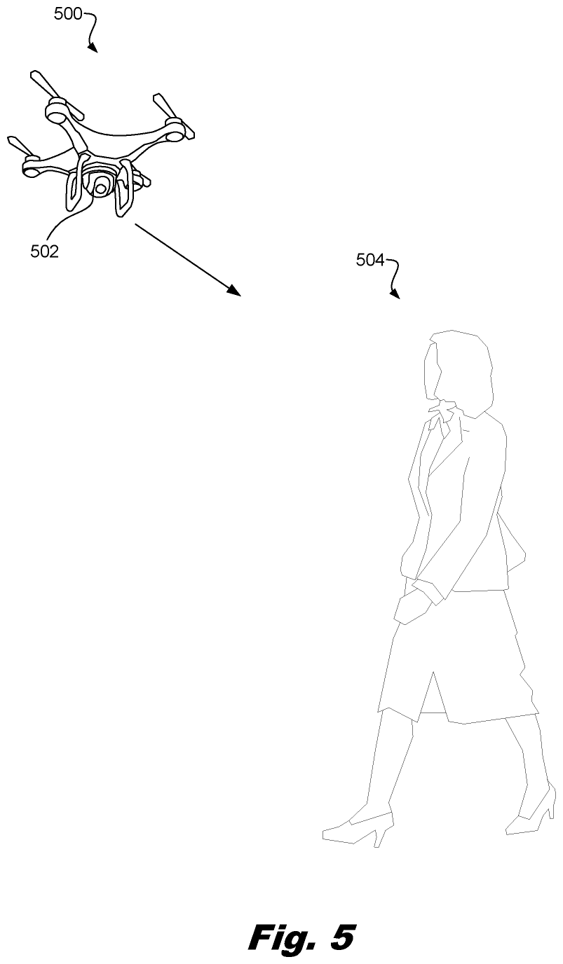

FIG. 5 depicts an example of a UAV 500 performing a surveillance operation on a predetermined premises. In this example, the UAV 500 is moving through an air space of a predetermined premises. The UAV's camera 502 is activated to detect the presence of people on the premises. In the illustrated example, the UAV 500 detects a person 504. In response to determining the presence of a person on the premise, the UAV 500 lowers its altitude to a facial recognition level. The facial recognition level can be any appropriate altitude that allows the camera 502 to gather enough information about the person's face to perform a facial recognition analysis. For example, the facial recognition level can be the same altitude as the person's face. In other examples, the facial recognition level can be within six feet of the person 504.

Before detecting the person, the UAV 500 can move throughout the airspace at an altitude that is not conducive to gather enough detail to perform the facial recognition analysis. At these higher altitudes, the UAV 500 can cover more area in a shorter amount of time. At this higher altitude, the resolution of the UAV's camera 502 does not have to gather a high level of detail, just enough detail to determine the presence of a person. In response to determining the presence of the person on the premise, however, the UAV 500 can move towards the person by using the propulsion system to lower its altitude and move the UAV closer to the proximity of the person.

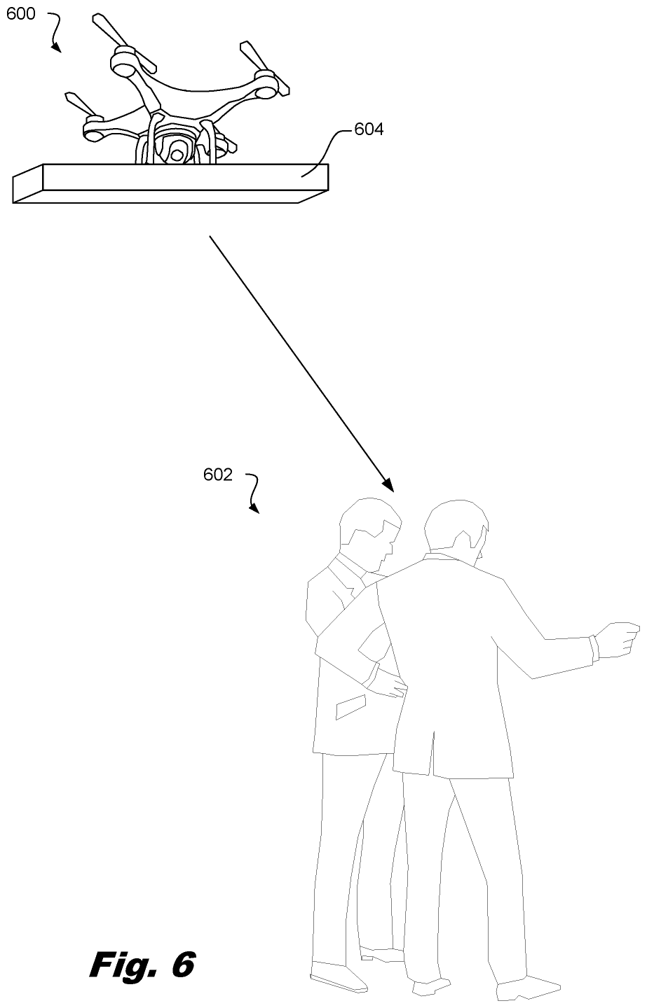

Now referring to FIG. 6, the UAV 600 can continue to perform a surveillance operation while charging. In the depicted example, the UAV 600 continues to perform a surveillance operation by watching persons 602 located within the line of sight of the UAV 600 and within in the predetermined facility while charging on the charging station 604.

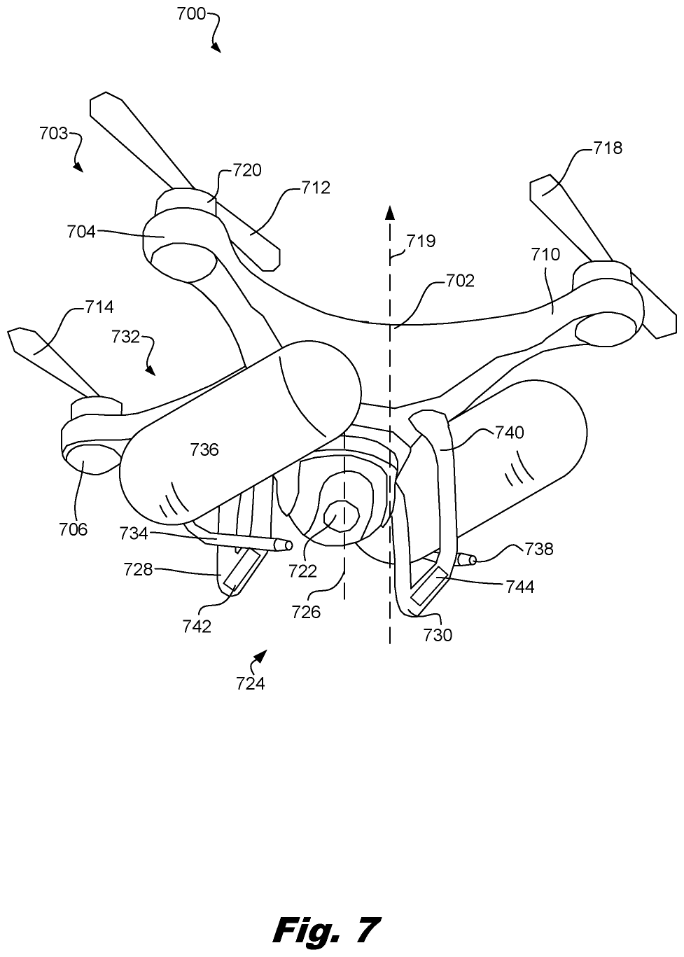

FIG. 7 shows that the UAV 700 can include an applicator 732 connected to the body 702. The exemplary applicator 732 includes a channel 734, a chamber 736 in fluid communication with the channel 734, and a nozzle 738 in fluid communication with the channel 734. In this example, the nozzle 738 is angled to eject a fluid in a direction that is angled with respect to the vertical direction 719. According to the illustrated embodiment, the chamber 736 can be connected to the body 702 through the legs 740 of the skids 728, 730. In other examples, the chamber can be secured directly to the UAV's body 702. In yet another example, the chamber is defined by an inside surface of the UAV's body 702.

In the example of FIG. 7, the applicator can include multiple chambers, multiple nozzles, and multiple channels connecting the respective nozzles with the appropriate chambers. The chamber 736 can include any appropriate type of fluid, such as a liquid or a gas that can be ejected out of the nozzle. In some examples, the fluid is a lachrymatory agent that triggers a response to a person's eyes, respiratory system, and/or skin. The physiological response can include irritation, pain, vomiting, and even blindness. The lachrymatory agent can include oleoresin capsicum gas, often known as pepper spray; 2-chlorobenzalmalononitrile; dibenzoxazepine; phenacyl chloride; nonivamide; bromoacetone; xylyl bromide; syn-propanethial-S-oxide; mace, which is a branded mixture of lachrymatory agents; other agents; or combinations thereof. In other embodiments, the applicator can apply fogging agents, inhalants, smoke, or other types of non-lachrymatory agents. In additional embodiments the fluid is a dye marking spray, such as Disperse Red 9 (1-methylamino anthraquinone), or the like. Alternatively, the fluid can be a deactivating spray, such as a fire retardant, a chemical retardant, or another emergency based payload.

The nozzles 738 can be angled with respect to the vertical direction 719 so that the nozzle 738 ejects the fluid at an angle that is transverse the vertical direction 719. In contrast with agricultural applications where liquids are released from UAVs in a downward direction, in this application the nozzles are angled with respect to the downward direction to enable the UAV 700 to hit a target that is laterally located with respect to the UAV at the time that the fluid is ejected. For example, the UAV can apply the lachrymatory agent on an intruder that is laterally located with respect to the UAV when the UAV is next to the intruder. The UAV can be lower than the top of the intruder to perform a facial recognition analysis when the UAV determines to apply the lachrymatory agent. Thus, the UAV application of fluid differs from conventional UAV fluid applications. Further, the downdraft from the UAV's rotors tend to assist the liquid from conventional UAVs towards crops or other targets that are located beneath the UAV. Thus, hitting a target at a similar altitude as the UAV results in different technical considerations than merely dropping a fluid from overhead.

Since liquid droplets are relatively light compared to solid projectiles that can be released from a UAV, the droplets are more prone to drift from the rotors' downdraft. To counter the downdraft affect, in some examples, the ejected fluid has droplets with a size greater than 400 micron, which can have a greater momentum and are therefore less prone to drifting due to the rotors' downdraft. Further, the greater mass of the droplets allow the droplets to travel faster. This advantageously causes the droplet to travel through airspace affected by the downdraft more quickly, thereby minimizing the downdraft's effect on the droplets.

In some embodiments, the UAV 700 can include other features configured to engage an intruder. For example, the UAV 700 can be equipped with Tasers or other electrical discharge components. The UAV 700 can also include nets, trip wires, ropes, chains, non-lethal projectiles, or other types of components to be used to capture an intruder. Further, the UAV 700 can include light based irritants, such as lasers, flashing lights, light focusing beams, other types of lights, or combinations thereof. Also, the UAV 700 can include an acoustic based irritant, such as sirens, whistles, sonic disruptive devices, speakers, alarms, other types of acoustic based irritants, or combinations thereof.

Another feature that can be incorporated into to the UAV to minimize the effect of downdraft of the laterally ejected fluid is a downdraft deflector that is positioned between the rotor and the nozzles. The downdraft deflector can deflect the moving air away from the nozzle, thereby minimizing the downward force that might otherwise cause the fluid to drift away from the UAV's target.

FIG. 8 depicts an example of a deflector 800 positioned above the chamber 802. In this example, the UAV is hidden for illustration. Being placed immediately above the chamber 802, the deflector 800 can be positioned between the rotor and the nozzle 804. In this example, the deflector 800 redirects the downdraft laterally and thereby away from the nozzle 804.

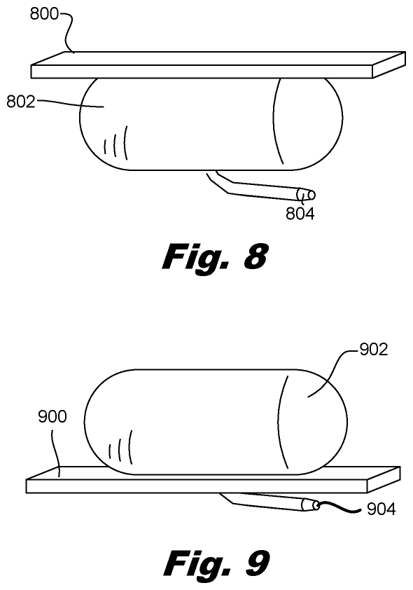

FIG. 9 depicts an example of a deflector 900 where the deflector is positioned below the chamber 902. In this example, the deflector is positioned farther away from the rotor. Thus, the downdraft force on the deflector 900 can be reduced.

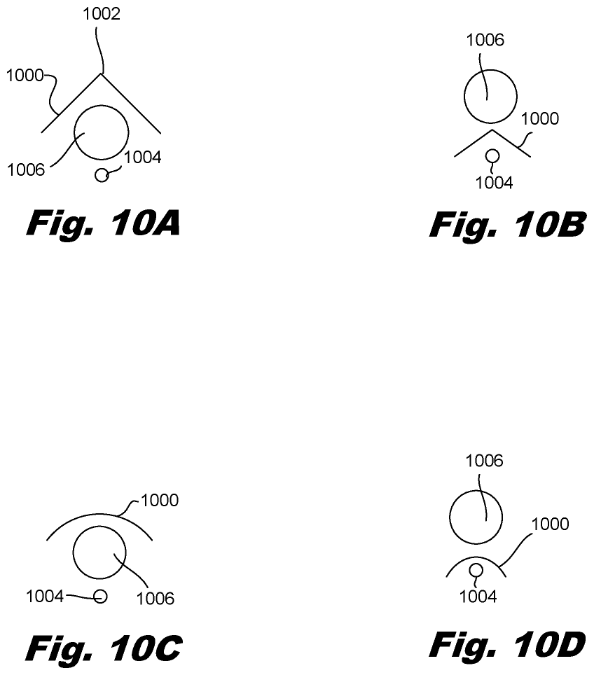

FIG. 10A depicts another example of a deflector 1000. In some embodiments, the deflector 1000 can be shaped to divert the downward draft away from the nozzle 1004. For example the deflector 1000 of FIG. 10A has a triangular shape with an apex 1002 of the deflector positioned to divert the downdraft away from the nozzle 1004 and the chamber 1006 at an angle. Similarly, FIG. 10B depicts an example of a deflector 1000 with a triangular shape. In this embodiment, the deflector 1000 is position between the chamber 1006 and the nozzle 1004. FIG. 10C depicts another embodiment of a deflector 1000 according to the present disclosure. The embodiment illustrated by FIG. 10C can include a deflector 1000 positioned above the chamber 1006 and the nozzle 1004. In this embodiment, the deflector 1000 includes a curved shape that directs the downdraft away from the nozzle 1004. Similarly, FIG. 10D depicts an example of a deflector 1000 with a curved shape. In this embodiment, the deflector 1000 is position between the chamber 1006 and the nozzle 1004.

While the examples of deflectors have been depicted above in FIGS. 10A-10D with specific locations and specific shapes, any appropriate position and/or shape can be used in accordance with the principles described herein. For example, the deflector can include a flat shape, a triangular shape, a curved shaped, a domed shape, an asymmetric shape, a curve with increasing radii, a curve with decreasing radii, a spherical shape, another type of shape, or combinations thereof. The deflector can have an aerodynamic contour that minimally affects the dynamics of the rotor. In some instances, the deflector can improve the overall aerodynamic contour of the UAV by deflecting the downdraft away from portions of the UAV that may not be particularly aerodynamic. For example, in some cases, the skids, the nozzle, the channel, the chamber, and/or other portions of the UAV can reduce the aerodynamic efficiency of the UAV. However, in this circumstance, the deflector can direct the airflow away from the less aerodynamic components to improve the overall aerodynamics of the UAV. In some instances, the deflector can also reduce the noise of the UAV's propulsion system. Thus, the UAV can be less prone to being detected when the UAV incorporates a deflector.

The deflector can be made of any appropriate type of material. In some examples, a list of non-exhaustive materials that can be used for the deflector includes acrylic glass, a plastic, a metal, a composite, another type of material, and combinations thereof.

The UAV can include other features that contribute to the UAV being less prone to detection. For example, the motors used to rotate the rotor can include noise reduced or silent motors.

According to one example the vanes can include a vane design, geometry, material, surface finish, and/or additional feature to minimize sound and increase stealth of the UAV. In one example, the vane is feathered to reduce or eliminate audible rotor wash. Alternatively, a motor and/or motor shield can be fitted adjacent to the rotor or motor to reduce audible sound of the UAV. Wave cancelling systems can be used to minimize sound emanated by the UAV. In one instance, a counter-rotating vane can be implemented to provide a cancelling soundwave. Alternatively, a microphone, processor, and speaker can be implemented to actively analyze and cancel any noise made by the UAV, thereby adding stealth. Similarly, sub-motor air traps or other buffers can be included to reduce or eliminate rotor downwash within a certain distance of the UAV.

In some cases, the UAV, or at least components of the UAV, can be made of materials that allow the UAV to be camouflaged within the UAV's environment. In one embodiment, the UAV can include surfaces configured to react to lighting and mimic its surroundings. In one embodiment, optical sensors can be used to detect general surroundings, a processor can then analyze the optical sensors, and a light modifiable surface can then be selectively modified to blend in to its surroundings. The modifiable surface can include organic light emitting diodes (OLEDs) and similar technologies that allow for images to be projected onto irregularly shaped surfaces.

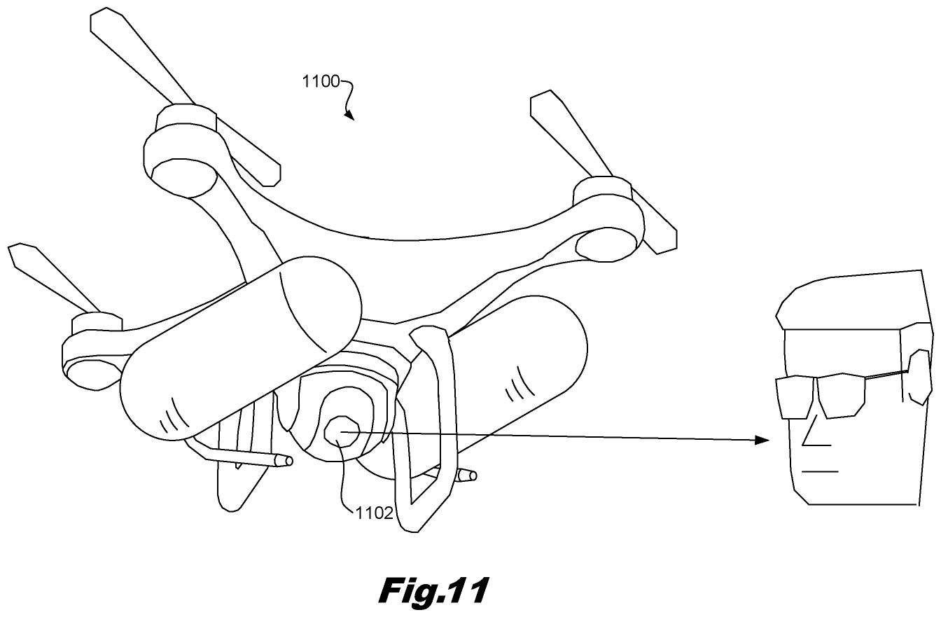

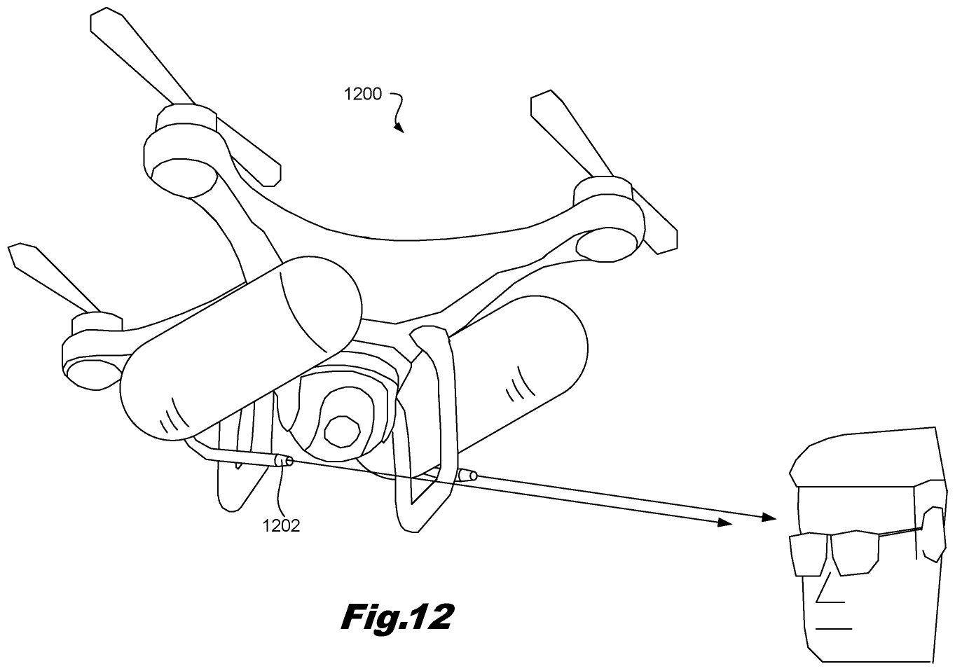

FIG. 11 illustrates the UAV 1100 at an altitude level where the camera 1102 can gather sufficient detail to perform a facial recognition analysis. The first portion of the analysis can include gathering information about the feature of the person's face. While any appropriate type of facial recognition can be used, some facial recognition procedures include identifying facial features by extracting features from an image of the subject's face. For example, a procedure can analyze the relative position, size, and/or shape of the eyes, nose, cheekbones, and jaw. These features can be compared with other images to find matching features. Other procedures include normalizing a gallery of face images, compressing the face data, and saving the data in the image that is useful for face recognition. Recognition procedures can include approaches that distinguish features and/or distil an image into values and compares the values of images.

A non-exhaustive list of facial recognition procedures that can be compatible with the principles described in the present disclosure include principal component analysis, linear discriminate analysis, elastic bunch graph matching, hidden Markov model, multilinear subspace learning, neuronal motivated dynamic link matching, other types of facial recognition procedures, other types of procedures, or combinations thereof.

In some cases, three-dimensional face recognition can be used. This technique can use three dimensional sensors to capture information about the shape of a face. The captured data can be used to identify distinctive features on the surface of a face, such as the contour of the eye sockets, nose, and chin. Benefits to the three-dimensional face recognition are that this approach is not affected by lighting changes and can be used from a range of viewing angles. In one example, the three-dimensional data can be gathered using multiple tracking cameras that point at different angles. For example, one camera can point at the front of the subject, another camera can point to a side of the face, and a third camera can be positioned at another angle.

In another approach, the details of the skin can be used for facial recognition. This approach can include analyzing unique lines in the skin, patterns in the skin, and spots in the skin. In some cases, this skin data can be correlated into mathematical values for comparison. In some examples, thermal cameras can detect the shape of the head and ignore the person's accessories such as glasses, hats, or make up.

In addition to standard CCD or other camera systems, the UAV can include a broad spectrum camera configured to detect light in non-optical ranges, including infrared, ultraviolet, X-rays, and the like. In addition to the above-mentioned optical sensor systems, any number of non-optical detection systems can be used by the UAV to improve performance and to surveil a designated area. Non-optical detection systems can include, but are in no way limited to, radar or sonar.

The information gathered from the camera can be processed with a processor on the UAV or a remote device that is in communication with the UAV. Further, the data information about the person's face can be compared to data that is in the same or at least a similar format in a database for individuals that are cleared to be on the premise. The database can undergo frequent updates as people are placed on and off the list. For example, former employees at a facility can be removed from being allowed on the premise after their employment is terminated. In some examples, the database includes data regarding when specific people are cleared to be on the premise, which can change throughout the day, week, or another time period. For example, all current employees can be allowed on the predetermined premise just during business hours. Thus, if the UAV recognized their faces during the day time hours, the UAV is likely to find a match for detected persons in the clear individuals list. On the other hand, if the same person was on the premise after hours, the UAV would not find a match. In some cases, the database is structured such that the UAV finds a match, but has an indicator informing the UAV that the detected person is not supposed to be on the premise. In some cases, the database also includes at least one person who is never allowed on the premise. In some examples, when the person is not in the database, the UAV can classify the person as an intruder. In other examples, when the person has an identity in the database, but is not listed as a cleared individual for the time of day or at all, the UAV can classify the person as an intruder.

FIG. 12 illustrates how the UAV 1200 can take a number of appropriate actions in response to determining that a person is an intruder. In some examples, the UAV 1200 can be governed by a policy that prescribes how the UAV is to respond based on a number of considerations. Whether the person is classified as an intruder can be just one of multiple considerations.

In those circumstances where the intruder appears to be aggressive and/or potentially harmful to the premise or equipment or individuals on the premise, the UAV 1200 can respond by applying the lachrymatory agent to the person. Applying the lachrymatory agent can be accomplished by positioning the UAV within a distance from the intruder so that the intruder is within range of the lachrymatory agent. In some cases, the nozzles 1202 are also controllably adjustable so that the UAV does not have to change its location and/or orientation to aim the lachrymatory agent at the intruder.

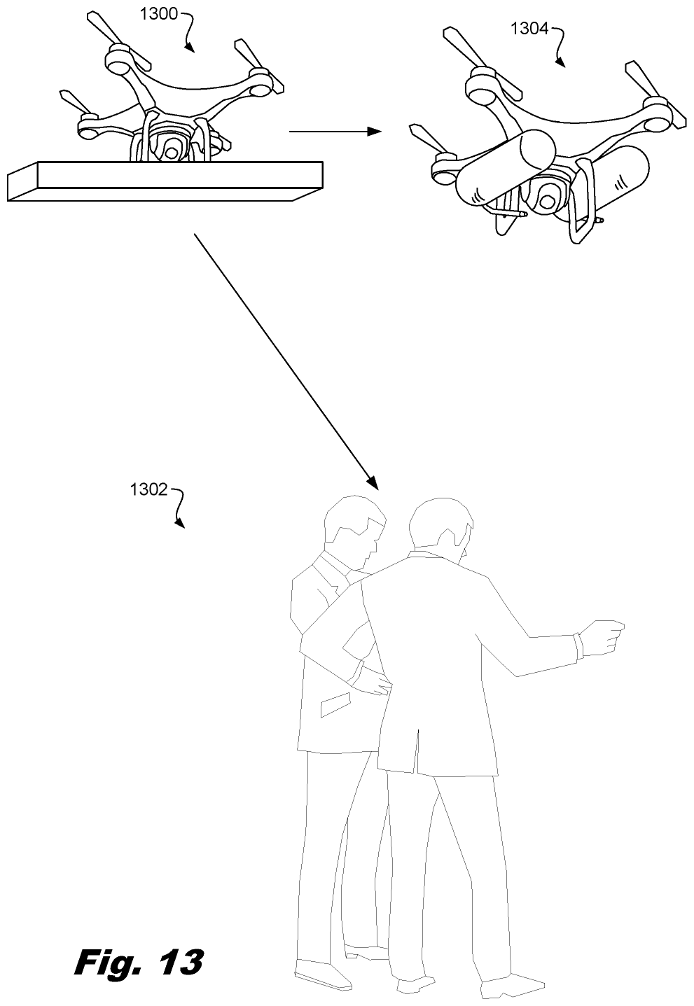

In FIG. 13, the UAV 1300 continues to perform a surveillance operation by communicating the location of the persons 1302 to a second UAV 1304. In this circumstance, the UAV 1300 and the second UAV 1304 can coordinate efforts to address the situation of the persons 1302 being located on the premises. While charging, the UAV can perform any appropriate type of surveillance operation. A non-exhaustive list of surveillance operations that can be performed by the UAV while charging include watching persons, performing a facial recognition analysis, performing another type of analysis, communicating information about persons on the premises, sending instruction to another device or authorities concerning people on the premises, performing another type of surveillance operation, or combinations thereof.

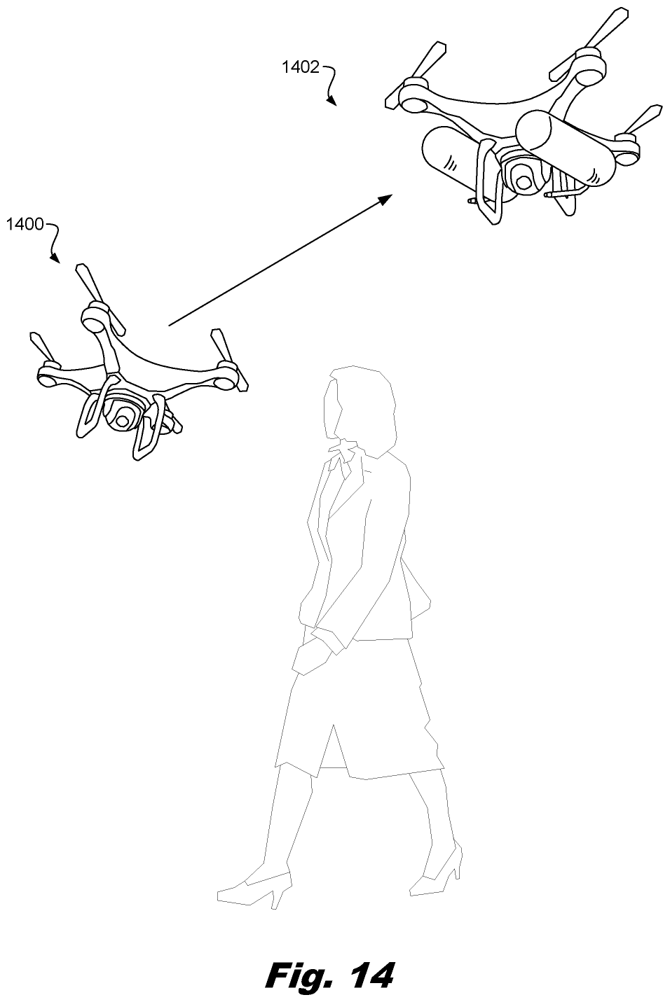

FIG. 14 depicts an example of a UAV 1400 coordinating with second UAV 1402 to perform a surveillance operation. In this example, the UAV 1400 can be coordinating efforts with the second UAV 1402. For example, the UAV 1400 can be performing a facial recognition analysis and sending instructions to the second UAV 1402 to apply a lachrymatory agent if the UAV 1400 determines that the person is not cleared to be on the premises.

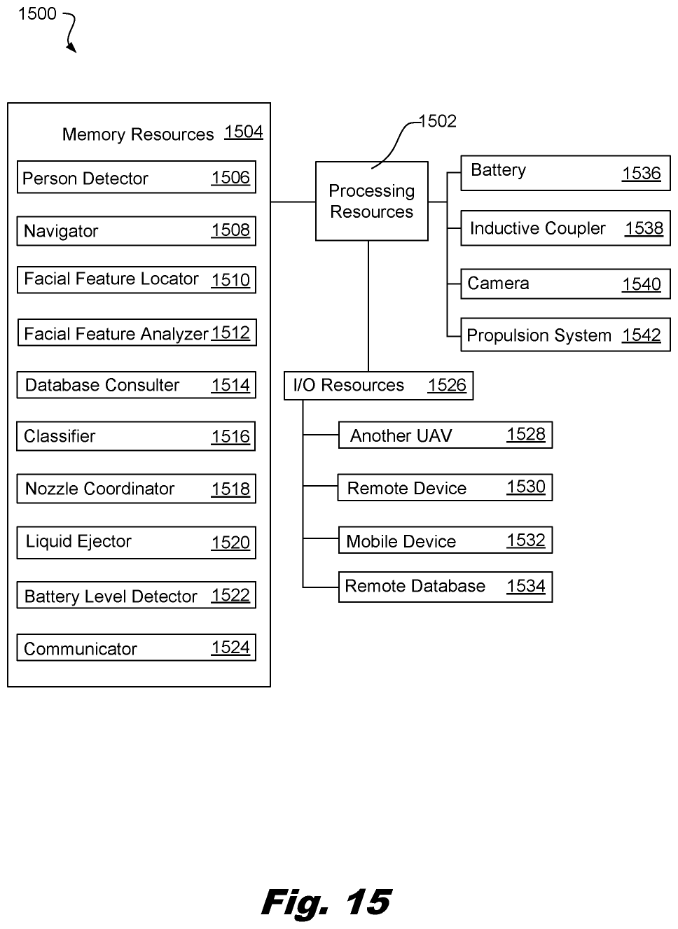

FIG. 15 illustrates a block diagram of an example of a control module 1500 for operating the UAV. The control module 1500 can include a combination of hardware and program instructions for executing the functions of the control module 1500. In this example, the control module 1500 includes processing resources 1502 that are in communication with memory resources 1504. Processing resources 1502 include at least one processor and other resources used to process programmed instructions. The memory resources 1504 represent generally any memory capable of storing data such as programmed instructions or data structures used by the system 1500. The programmed instructions shown stored in the memory resources 1504 include a person detector 1506, a navigator 1508, a facial feature locator 1510, a facial feature analyzer 1512, a database consulter 1514, a classifier 1516, a nozzle coordinator 1518, a liquid ejector 1520, a battery level detector 1522, and a communicator 1524.

Additionally, the processing resources 1502 can be in communication is input/output (I/O) resources 1526. The I/O resources 1526 can put the processing resources into communication with another UAV 1528, a remote device 1530, a mobile device 1532, a remote database 1534, another type of device, or combinations thereof.

The processing resources 1502, memory resources 1504, the UAV, another UAV 1528, a remote device 1530, a mobile device 1532, a remote database 1534, another type of device, or combinations thereof can communicate over any appropriate network and/or protocol. For example, these devices can be capable of communicating using the ZigBee protocol, Z-Wave protocol, BlueTooth protocol, Wi-Fi protocol, Global System for Mobile Communications (GSM) standard, another standard, or combinations thereof.

The memory resources 1504 include a computer readable storage medium that contains computer readable program code to cause tasks to be executed by the processing resources 1502. The computer readable storage medium can be a tangible and/or non-transitory storage medium. The computer readable storage medium can be any appropriate storage medium that is not a transmission storage medium. A non-exhaustive list of computer readable storage medium types includes non-volatile memory, volatile memory, random access memory, write only memory, flash memory, electrically erasable program read only memory, magnetic based memory, other types of memory, or combinations thereof.

The processing resources 1502 can also be in communication with a battery 1536 of the UAV, an inductive coupler 1538 (or another type of mechanism for charging the UAV), a camera 1540 of the UAV, and a propulsion system 1542 of the UAV.

The person detector 1506 represents programmed instructions that, when executed, cause the processing resources 1502 to detect when a person is located on the premises. The person detector 1506 can use at least one sensor incorporated into the UAV to determine that a person is located on the premises. For example, the person detector can use the camera 1540, a microphone, a distance sensor, input from another device, another type of sensor, or combinations thereof.

The navigator 1508 represents programmed instructions that, when executed, cause the processing resources 1502 to cause the propulsion system 1542 to move the UAV to a desired location. The navigator 1508 can cause the propulsion system to lower its elevation to gather data, such as facial information; to raise its elevation to gather data, such as gathering a broad view of a premises; to move laterally to a desired coordinate; to move to another location; or combinations thereof.

The facial feature locator 1510 represents programmed instructions that, when executed, cause the processing resources 1502 to locate the features of a person's face. In some examples, the facial feature locator can determine where facial features, such as nose, mouth, chin, ears, eyes, and so forth are located.

The facial feature analyzer 1512 represents programmed instructions that, when executed, cause the processing resources 1502 to analyze the features of the person's face. For example, the analyzer can determine the dimensions of the person's facial features, determine the distance between the person's facial features, assign characteristics of the person's facial features to a value, perform other types of analysis, or combinations thereof.

The database consulter 1514 represents programmed instructions that, when executed, cause the processing resources 1502 to consult a database that contains the identities of individuals who are cleared to be on the premises. In some circumstances, the database also includes the identities of individuals who are not allowed to be on the premises. The analyzed information can be compared to the information contained in the database. In some cases, the database is a database stored in the UAV. In alternative embodiments, the database is stored in a remote device.

The classifier represents programmed instructions that, when executed, cause the processing resources 1502 to classify a person based on the analyzed information and the information in the database. In those circumstances where a match exists between the analyzed facial features and the information associated with a cleared individual in the database, the classifier can classify an individual as a person that is allowed to be on the premises. In other examples, the classifier can classify a person as an intruder when no match exists between the person's analyzed facial data and the information in the database. In other examples, the classifier can classify the person as an intruder in those circumstances where the person's analyzed facial data matches an identity in the database that has already been classified as a potential intruder.

The liquid ejector 1520 represents programmed instructions that, when executed, cause the processing resources 1502 to eject a liquid through the applicator. The liquid ejector can cause the liquid to be ejected in response to determining that a person is an intruder. In some circumstances, a number of conditions are met, including that the person is classified as an intruder, before the liquid ejector causes the liquid to be ejected.

The battery level detector 1522 represents programmed instructions that, when executed, cause the processing resources 1502 to detect the UAV's battery level. In response to detecting that the battery level is low, the UAV can travel to a charging station to recharge. The UAV can continue to perform surveillance operations while charging. When the battery level detector 1522 detects that the battery is recharged, the UAV can continue to perform surveillance operations at a location other than the charging station and/or while traveling through an air space.

The communicator 1524 represents programmed instructions that, when executed, cause the processing resources 1502 the UAV to communicate with a remote device. The remote device can be another UAV, a remote device, a mobile device, a database, an authority, an entity, another type of device or person, or combinations thereof.

Further, the memory resources 1504 can be part of an installation package. In response to installing the installation package, the programmed instructions of the memory resources 1504 can be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources 1504 can include integrated memory such as a hard drive, a solid state hard drive, or the like.

In some examples, the processing resources 1502 and the memory resources 1504 can be located within the UAV, another UAV, a mobile device, a remote device, another type of device, or combinations thereof. The memory resources 1504 can be part of any of these device's main memory, caches, registers, non-volatile memory, or elsewhere in their memory hierarchy. Alternatively, the memory resources 1504 can be in communication with the processing resources 1502 over a network. Further, the data structures, such as the libraries, can be accessed from a remote location over a network connection while the programmed instructions are located locally.

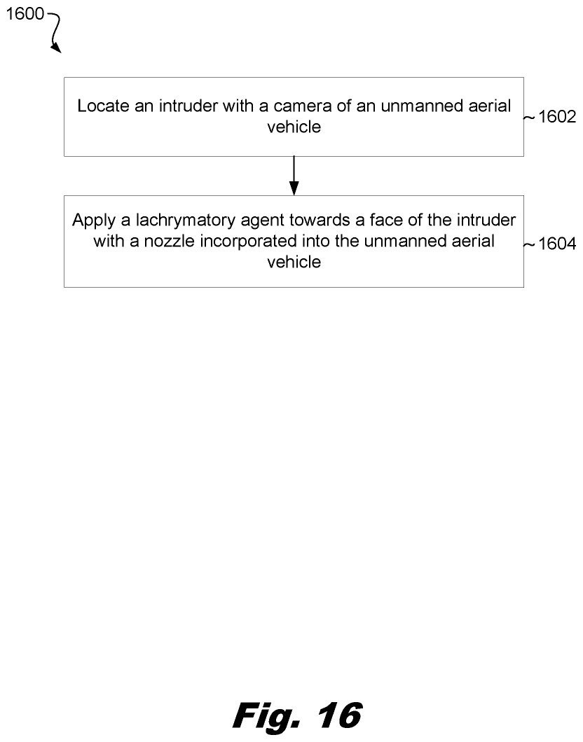

FIG. 16 depicts a method 1600 of using a UAV. In this example, the method 1600 includes locating 1602 an intruder with a camera of a UAV and applying 1604 a lachrymatory agent towards a face of the intruder with a nozzle incorporated into the UAV.

At block 1602, the intruder is located with the camera. Any appropriate type of camera can be used to identify the presence of the intruder. Further, the UAV can use sensors in addition to the camera to determine the presence of the intruder.

At block 1604, a lachrymatory agent is applied to the intruder. The lachrymatory agent can cause the intruder to have a physiological reaction that temporarily disables the intruder from accomplishing an undesirable task or allows authorities more time to arrive to arrest the intruder.

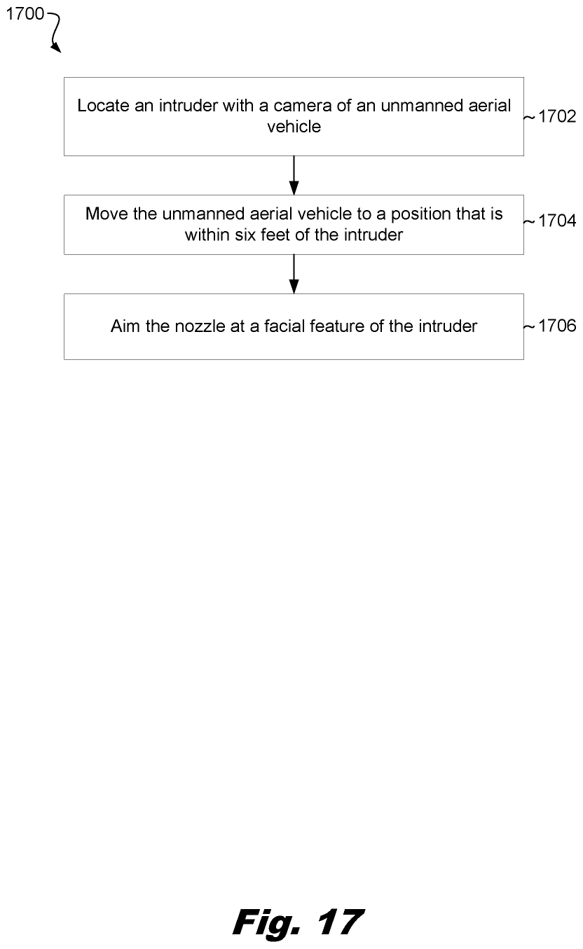

FIG. 17 depicts a method 1700 of using a UAV. In this example, the method 1700 includes locating 1702 an intruder with a camera of a UAV, moving 1704 the UAV to a position that is within six feet of the intruder, and aiming 1706 the nozzle at a facial feature of the intruder.

At block 1704, the UAV is moved to a position that is within six feet of the intruder. Moving the UAV can include lowering the altitude of the UAV so that the UAV is at an altitude that is the same or similar to the altitude of the intruder's face.

At block 1706, the nozzle is aimed at a facial feature of the intruder. In some cases, the nozzle can be aimed in a direction that is substantially transverse to a gravitational force on the UAV.

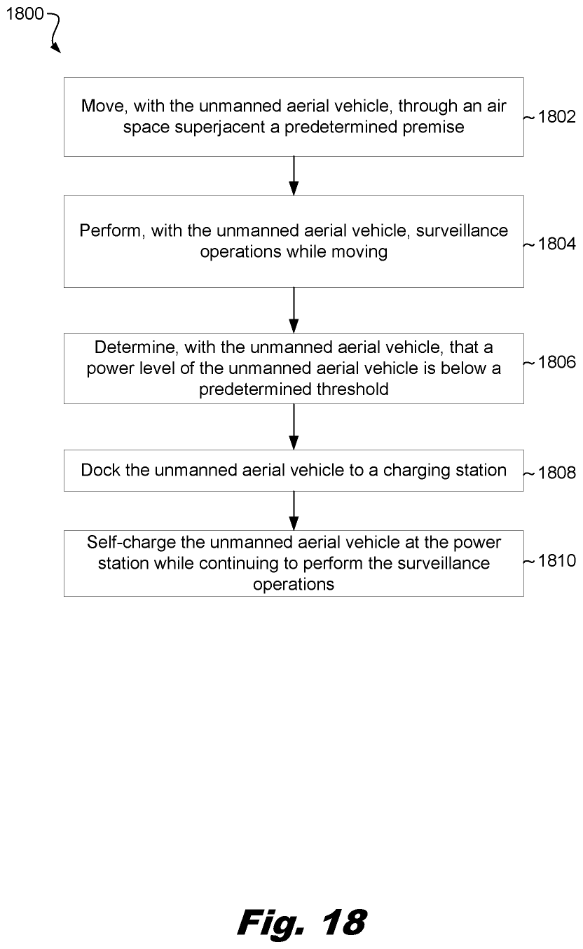

FIG. 18 depicts a method 1800 of using a UAV. In this example, the method 1800 includes moving 1802, with a UAV, through an air space superjacent a predetermined premises; performing 1804, with a UAV, surveillance operations while moving; determining 1806, with a UAV, that a power level of the UAV is below a predetermined threshold; docking 1808 the UAV to a charging station; and self-charging 1810 at the charging station while continuing to perform the surveillance operations.

At block 1802, the UAV moves through the air space that is superjacent the determined premises. In this manner, the UAV can perform surveillance operations. The UAV can be moved with the propulsion system.

At block 1806, a power level of the UAV is determined to be below a predetermined threshold. In this example, the UAV can self-determine when to recharge. The predetermined threshold can be set at any appropriate level that allows the UAV to get to a charging station.

At block 1808, the UAV continues to perform surveillance operations while charging. Thus, an intruder has no opportunity to enter the premises when the UAV is shut down for charging. In some examples, the UAV coordinates when it charges with at least another UAV so that the UAVs are not charging at the same time. Thus, at least one UAV is easily deployed to a location to address the presence of an intruder or another person located on the premises.

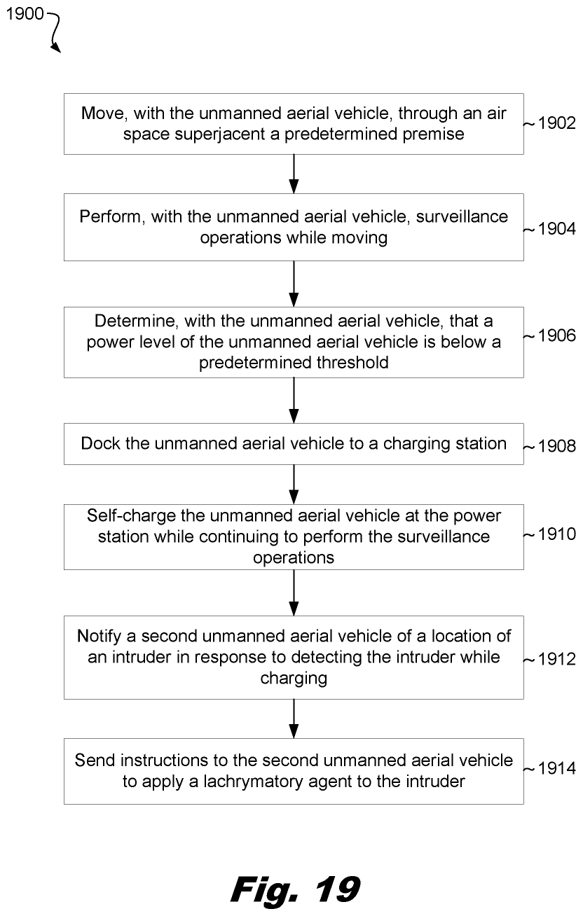

FIG. 19 depicts a method 1900 of using a UAV. In this example, the method 1900 includes moving 1902, with a UAV, through an air space superjacent a predetermined premises; performing 1904, with a UAV, surveillance operations while moving; determining 1906, with a UAV, that a power level of the UAV is below a predetermined threshold; docking 1908 the UAV to a charging station; self-charging 1910 at the charging station while continuing to perform the surveillance operations; notifying 1912 a second UAV of a location of an intruder in response to detecting the intruder while charging; and sending 1914 instructions to the second UAV to apply a lachrymatory agent to the intruder.

At block 1912, the UAV notifies a second UAV that an intruder is identified. Since the UAV is charging, the second UAV can be called upon to address the issue with the intruder so that the UAV can continue to charge. In some cases, when a UAV detects the presence of an intruder, regardless of whether the UAV is charging or traveling, the UAV calls upon at least one other UAV for assistance.

In some cases, the UAV that is charging continues to monitor the intruder, even when the second UAV is involved. In some cases, the UAV that is charging orchestrates an effort with one or more additional UAVs to address the issues with the intruder. In other examples, the UAV that is charging takes orders from another UAV while charging.

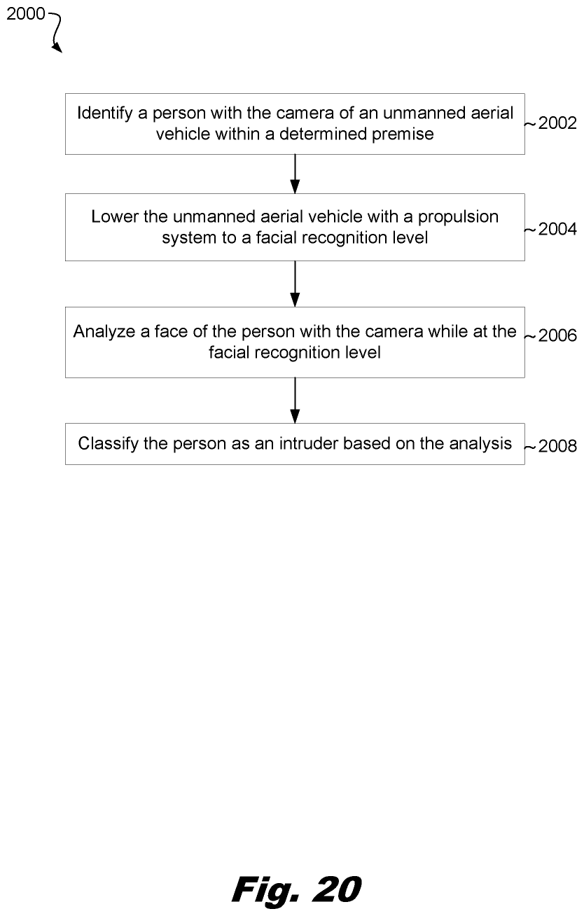

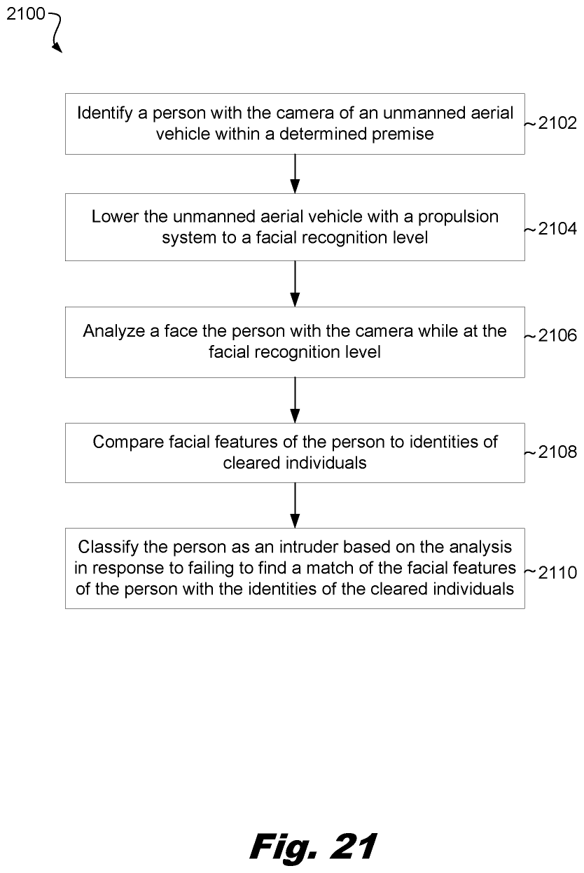

FIG. 20 depicts an alternative method 2000 of using a UAV. In this example, the method 2000 includes identifying 2002 with the camera of a UAV within a predetermined premises, lowering 2004 the UAV with a propulsion system to a facial recognition level, analyzing 2006 a face of the person with the camera while at the facial recognition level, and classifying 2008 the person as an intruder based on the analysis.

At block 2004, the UAV is lowered to a facial recognition level. In some examples, the facial recognition level is at the same altitude as the person's face. In other examples, the facial recognition level is within six feet of the altitude of the person's face.

FIG. 21 depicts a method 21 of using a UAV. In this example, the method 2100 includes identifying 2102 a person with the camera of a UAV within a predetermined premises, lowering 2104 the UAV with a propulsion system to a facial recognition level, analyzing 2106 a face of the person with the camera while at the facial recognition level, comparing 2108 facial features of the person to identities of cleared individuals, and classifying 2110 the person as an intruder based on the analysis in response to failing to find a match of the facial features of the person with the identities of the cleared individuals.

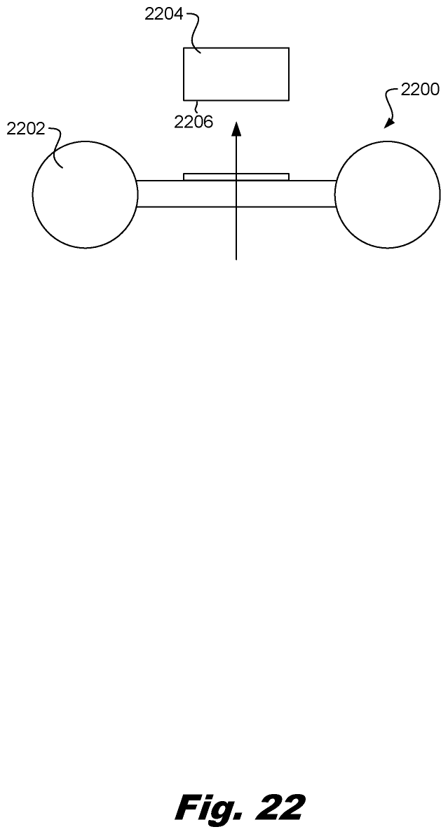

While the examples above have been described with reference to specific features and components, any appropriate type of structure can be used for the UAV in accordance with the principles described in the present disclosure. In one example, at least some of the components of the UAV, such as the frame or another type of member, is inflatable. The gas used to inflate the inflatable member can be ambient. In some cases, the gas is a gas that is lighter than ambient air, such as helium. Using a gas in an inflatable member of the UAV can cause the UAV to be lighter overall and thereby reduce the drone's power requirements. This natural lift or buoyancy can be used to reduce the power requirements of the UAV. In some cases, the UAV can have an incorporated compressor that allows the UAV to self-inflate. In those circumstances where the gas is lighter than ambient air, the UAV can float without applying power. Power applied by the UAV can be used to keep the UAV down rather than keeping the UAV up. In FIG. 22, an example of a UAV 2200 with an inflatable section 2202 due to a light-weight gas is shown. The UAV 2200 can charge at a charging station 2204 where the UAV 2200 is configured to make contact with the underside 2206 of the charging station 2204. In this example, the UAV 2200 can float into the charging station's underside 2206 and use little to no power to maintain its vertical position while charging. Further, in situations where a light-weight gas is used, the UAV can float and the rotors can be used for providing the UAV stability and direction. Due to the lower power requirements, less noise can be generated from the embodiments using a light-weight gas thereby providing a UAV that is more stealth and less prone to detection by an intruder. A flotation type drone can be shaped in an airfoil type formed to assist in achieving further amounts of lift during forward flight. The airfoil type shape could assist in reducing power requirements.

While the present disclosure details certain embodiments in which the UAV is used to monitor a premises and/or deter intruders, the exemplary system can be used for any number of purposes, both indoors and outdoors. According to one exemplary embodiment, the UAV can be configured to herd, combat, or defend against animals. Additionally, the present UAV design can be used for crowd management, airport surveillance, arena or sporting event security, and the like. In other embodiments, the UAV can also be used to monitor predetermined characteristics of a power distribution line that spans over some geographic area or region. In yet other embodiments, the UAV can be used to collect data from a remote area that is otherwise difficult to access.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. Often, the width of an object is transverse the object's length.

1-21. (canceled)

22. An unmanned aerial vehicle, comprising:
a body;
a propulsion system connected to the body, wherein the propulsion system generates a lift force in a vertical direction opposite of a gravitational force when activated;
a battery located within the body;
a charging receiver in electrical communication with the battery;
a camera connected to the body;
a memory and processor, the memory including programmed instructions that, when executed, cause the processor to:
conduct a surveillance operation with the camera while receiving an electrical charge through the charging receiver.

23. The unmanned aerial vehicle of claim 22, wherein the charging receiver is an inductive coil.

24. The unmanned aerial vehicle of claim 22, wherein the programmed instructions, when executed, cause the processor to operate the propulsion system to move the unmanned aerial vehicle within predetermined premise when the battery has a power level above a predetermined threshold.

25. The unmanned aerial vehicle of claim 22, wherein the programmed instructions, when executed, cause the processor to operate the propulsion system to dock the unmanned aerial vehicle at a charging station when the battery has a power level below a predetermined threshold.

26. The unmanned aerial vehicle of claim 22, wherein the programmed instructions, when executed, cause the processor to communicate with a remote device while the unmanned aerial vehicle is charging in response to detecting an intruder.

27. The unmanned aerial vehicle of claim 22, wherein the programmed instructions, when executed, cause the processor to communicate with a second unmanned aerial vehicle in response to detecting an intruder while charging.

28. The unmanned aerial vehicle of claim 22, wherein the programmed instructions, when executed, cause the processor to notify a second unmanned aerial vehicle of a location of an intruder in response to detecting the intruder while charging.

29. The unmanned aerial vehicle of claim 22, wherein the programmed instructions, when executed, cause the processor to send instructions to a second unmanned aerial vehicle to apply a lachrymatory agent to an intruder in response to detecting the intruder while charging.

30. The unmanned aerial vehicle of claim 22, wherein the programmed instructions, when executed, cause the processor to coordinate with a second unmanned aerial vehicle to perform the surveillance operation while charging.

31. The unmanned aerial vehicle of claim 22, wherein the surveillance operation is following an intruder.

32. A method of using an unmanned aerial vehicle, comprising:
moving, with the unmanned aerial vehicle, through an air space superjacent a predetermined premise;
performing, with the unmanned aerial vehicle, a surveillance operation while moving;
determining, with the unmanned aerial vehicle, that a power level of the unmanned aerial vehicle is below a predetermined threshold;
docking the unmanned aerial vehicle to a charging station; and
self-charging the unmanned aerial vehicle at the charging station while continuing to perform the surveillance operation.

33. The method of claim 32, wherein self-charging includes inductively charging the unmanned aerial vehicle at the charging station.

34. The method of claim 32, wherein moving the unmanned aerial vehicle within an air space of the predetermined premise occurs when the power level is above the predetermined threshold.

35. The method of claim 32, further including communicating with a remote device while the unmanned aerial vehicle is charging in response to detecting an intruder.

36. The method of claim 32, further including communicating with a second unmanned aerial vehicle in response to detecting an intruder while charging.

37. The method of claim 32, further including notifying a second unmanned aerial vehicle of a location of an intruder in response to detecting the intruder while charging.

38. The method of claim 32, further including sending instructions to a second unmanned aerial vehicle to apply a lachrymatory agent to an intruder in response to detecting the intruder while charging.

39. The method of claim 32, further including coordinating with a second unmanned aerial vehicle to perform the surveillance operation while charging.

40. The method of claim 32, further including coordinating with the second unmanned aerial vehicle to perform the surveillance operation while moving about an air space when the power level is above the predetermined threshold.

41. An unmanned aerial vehicle, comprising:
a body;
a propulsion system connected to the body, wherein the propulsion system generates a lift force in a vertical direction opposite of a gravitational force when activated;
a battery located within the body;
a charging receiver in electrical communication with the battery;
a camera connected to the body;
a memory and processor, the memory including programmed instructions that, when executed, cause the processor to:
conduct a surveillance operation with the camera while receiving an electrical charge through the charging receiver;
operate the propulsion system to move the unmanned aerial vehicle within predetermined premise when the battery has a power level above a predetermined threshold;
operate the propulsion system to dock the unmanned aerial vehicle at a charging station when the power level is below the predetermined threshold; and
coordinate with a second unmanned aerial vehicle to perform the surveillance operation while charging.

42-63. (canceled)
